(19) United States
(12) Patent Application Publication
(10) Pub. No.: US 2012/0103726 A1
(43) Pub. Date: May 3, 2012

(54) Tool Tray For A STEP LADDER

(76) Inventors: Carlo Morfidis, Scarborough (CA); David Zhu, Scarborough (CA); John Vagalatis, Scarborough (CA); Marvin M. Rosenberg, Toronto (CA)

(21) Appl. No.: 12/983,893

(22) Filed: Jan. 4, 2011

(30) Foreign Application Priority Data
Nov. 1, 2010 (CA) 2,719,812

(51) Int. Cl. E06C 7/14; E06C 7/50

(52) U.S. Cl. 182/129

(57) ABSTRACT

The tray or tray assembly of this invention allows hobbyists and professionals working on a step ladder to have easy and stable access to their tools and equipment. The tray is attached directly or by way of a support backing to struts on the ladder such that it projects outwards from the front or back to which it is attached. The tray or tray assembly can be built with a bracket that opposed diverging channels that engage diverging struts on the ladder so as to support the tray and its contents. As a result, the tray is vertically positioned within the footprint of the ladder, providing a convenient, stable, and safe arrangement by which the user may attend to the task at hand.

### TECHNICAL FIELD

This invention relates to industrial and consumer hardware, ladder accessories, and storage systems for tradesware equipment and supplies.

### BACKGROUND

Ladders are used by both professional tradespersons and by weekend hobbyists. Step ladders are useful devices for getting at high places, since that they are generally self-supporting, and provide a platform for the user to take their equipment and supplies needed for a particular task.

U.S. Pat. No. 3,822,847 refers to a detachable support fray for ladders that is removably attachable to the side rail of a ladder. U.S. Pat. No. 3,842,936 outlines a compartmentalized accessory tray assembly with a tray inside a housing. U.S. Pat. No. 4,029,280 refers to a step ladder attachment comprising a tray and various support means. U.S. Pat. No. 4,222,531 claims a ladder tray support attachment that attaches to a top platform of a step ladder.

U.S. Pat. No. 4,730,802 provides a tray having a bracket with diverging channel members that rest without any fasteners upon upper edges of the side rails of a step ladder. U.S. Pat. No. 4,949,925 outlines an adjustable, portable utility shelf having a tray designed for use as a ladder caddy. U.S. Design Pat. 388,882 provides sketches for a combined work ladder and platform. U.S. Pat. No. 5,333,823 relates to a detachable device holding apparatus that removably attaches to the top platform of a stepladder.

U.S. Pat. No. 5,342,088 outlines an attachment for a ladder, in which brackets are mounted to sides of a step ladder by spaced apart divergent channels. U.S. Pat. No. 5,511,753 refers to a paint can holder for suspending a paint can on the top shelf of a ladder. U.S. Pat. No. 5,542,553 refers to a ladder caddy with a container mechanism and a coupling mechanism to attach it to the side legs of a ladder. U.S. Pat. No. 5,647,453 provides a multi-purpose ladder apron adapted with a plurality of tool and accessory receptacles. U.S. Pat. No. 5,727,649 details a tool storage container with a support shelf for resting on the uppermost platform of a ladder. U.S. Pat. No. 5,836,557 refers to a utility tray assembly that is capable of being mounted on a shelf or step of a ladder. U.S. Pat. No. 5,873,43 outlines a step ladder tray that is securable to the top cap of a step ladder. U.S. Pat. No. 5,941,344 focuses on a portable ladder top work station tool box combination.

U.S. Pat. No. 6,000,497 (assigned to Cosco, Inc.) depicts a detachable tray for a step stool. U.S. Pat. No. 6,341,666 refers to a step ladder accessory tray with a clamping assembly attaching it to the fold-out shelf of a step ladder. U.S. Pat. No. 6,698,548 claims a tray with a latch mechanism for attaching to a ladder by way of a bolt. U.S. Pat. No. 6,877,586 depicts a hinge system for a combination hand truck, step ladder, and dolly device. U.S. Pat. No. 7,032,711 outlines a tool and hardware accessory securable to the top cap of a ladder using a clamping mechanism. U.S. Pat. No. 7,063,187 refers to a ladder attachment system for supporting several items with treaded inserts.

Published PCT application WO 99/09289 provides a tool box coupled to support brackets mounted on each front leg of a ladder. U.S. Pat. No. 7,128,187 depicts a step ladder with a pivoting utility tray. Published U.S. patent application 2005/0258002 has a drawing for a tool holding device for mounting on a step of a ladder.

Such ladder accessories lack the convenience, adaptability, safety, and dependability of the invention described here.

### SUMMARY OF THE INVENTION

This invention allows hobbyists and professionals such as electrical, plumbing and HVAC technicians to work on a step ladder, allowing them easy and stable access to their tools and equipment

The new design for tool trays mounted on a ladder described here helps ensure that the center of gravity of the toolbox is within the footprint of the ladder, ensuring a stable platform from which the user can do the work required. The design also helps ensure the ladder does not tip over when the user mounts or dismounts the ladder. The tool tray can be premounted on the ladder before it is positioned at the site of use.

One embodiment of the invention is an assembly in which a specially designed tool tray is attached to a step ladder. The ladder has a pair of upward support struts on a front or back side. Typically, the struts on the front or back of the ladder (or both) diverge from each other from top to bottom. Attached to the ladder is a tray or tray assembly with a platform supporting one or more open compartments suitable for holding tools or equipment. The tray is attached to diverging struts on the ladder such that when the ladder is positioned for climbing, the horizontal platform projects outwards from the front or back to which it is attached. The tray or tray assembly can be built with a bracket with opposed diverging channels that engage diverging struts on the ladder so as to support the tray and its contents. The channels diverge at an angle and with a span appropriate to attach to the ladder being used.

Another embodiment of the invention is the tray or tray assembly itself, which may be attached to the ladder, or sold separately. The tray or tray assembly has a substantially horizontal platform supporting open compartments suitable for holding tools or equipment. As before, the tray or tray assembly has a bracket that has opposed diverging channels that engage diverging struts on the front or the back of the ladder, such that when the ladder is positioned for climbing, the horizontal platform projects outwards from the front or back to which it is attached. As a result, the center of gravity of the tray or tray assembly is vertically positioned above and horizontally positioned within the footprint defined by support struts of the ladder when positioned for climbing.

In either of the aforesaid embodiments, the tray may be a one-piece apparatus attached directly to the ladder by way of the bracket having opposed diverging channels that engage said diverging struts so as to support the tray. Alternatively, there may be a tray assembly in which a tray suitable for holding tools or equipment is removably attached to a separate support. In this option, the support may have opposed diverging channels for attachment to the ladder, or may be attached to the front or the back of the ladder by other means.

The tray may be attached to the support, for example, by way of two or more hooks adapted to receive openings on the tray so as to support the tray against a vertical surface of the support. The hooks can be essentially an inverted V-shape, and attached to a surface of the support facing outwards from the ladder. They insert into openings on the tray, and hold the tray securely to the ladder.

The support may be adapted to include several upwardly oriented openings for receiving hand tools separate and apart from the tray. They may be located in the vertical face of the support, or they may be mounted outside the bracket so as to provide a strengthening role that prevents the bracket from spreading apart. The tray can be provided with a handle for carrying when not attached to a ladder. The tray can also be sized so that multiple trays are vertically stackable one upon another.

Other embodiments of the invention are various kits. One example is a kit for assembling the tray assembly, comprising one or more trays and one or more supports. Another example is a kit for assembling the ladder and the tray together, comprising the ladder, and either a one-piece tray or a tray and tray support. The ladder may also be manufactured and sold with the tray or just the support already attached.

Another embodiment of the invention is a method for securing a tool tray to a step ladder. The tray can be attached by way of its divergent channels to a pair of divergent support struts on the front or the back of said ladder. Previously or subsequently, the tray is attached to the support. When all put together and the ladder is positioned for climbing, the horizontal platform of the tray projects outwards from the front or back to which it is attached.

Other embodiments of the invention involve methods for manufacturing and assembling the various components of the apparatus and assemblies. Further embodiments of the invention will be apparent from the description that follows.

### DRAWINGS

FIG. 1 is a half-tone reproduction of a one-piece tray of this invention with diverging channels for direct attachment to the front or back of a step ladder.

FIG. 2(A) shows the tray attached to a step ladder. FIG. 2(B) shows that when attached to the ladder according to the invention, the center of gravity of the tray is above and within the footprint of the ladder.

FIG. 3(A) (angular view), FIG. 3(B) (side view), FIG. 3(C) (top view) and FIG. 3(D) (front view) are half-tone drawing showing an example of a tool tray adapted to be attached to a ladder by way of a tray support. Openings in the back receive hooks from the support.

FIG. 4(A) (angular view) and FIG. 4(B) (side view) shows a tool tray with separate open compartments for accommodating small tools and equipment.

FIG. 5(A) (angular view), FIG. 5(B) (side view),

FIG. 6(A) (top view), FIG. 6(B) (front view), and FIG. 6(C) (bottom view) show the tray attached to a tray support, which in turn can be mounted on the front or back of a step ladder by way of a bracket with diverging channels on the back of the support.

FIG. 7(A) (angular view from above back) and FIG. 7(B) (angular view from below front) show an exemplary tray support by itself. The bracket with diverging channels on the back of the support mounts the support onto the ladder.

FIG. 8(A) (top view), FIG. 8(B) (side view), and FIG. 8(C) (bottom view) provide details and dimensions of the same tray support. Dimensions are shown in inches.

FIG. 9(A) (side view), FIG. 9(B) (internal view), and FIG. 9(C) (front view) show two trays that have been shaped and proportioned so as to stack securely into each other. Dimensions are again shown in inches.

FIG. 10 is a drawing showing preferred dimensions for a tray support bracket of this invention.

### DETAILED DESCRIPTION

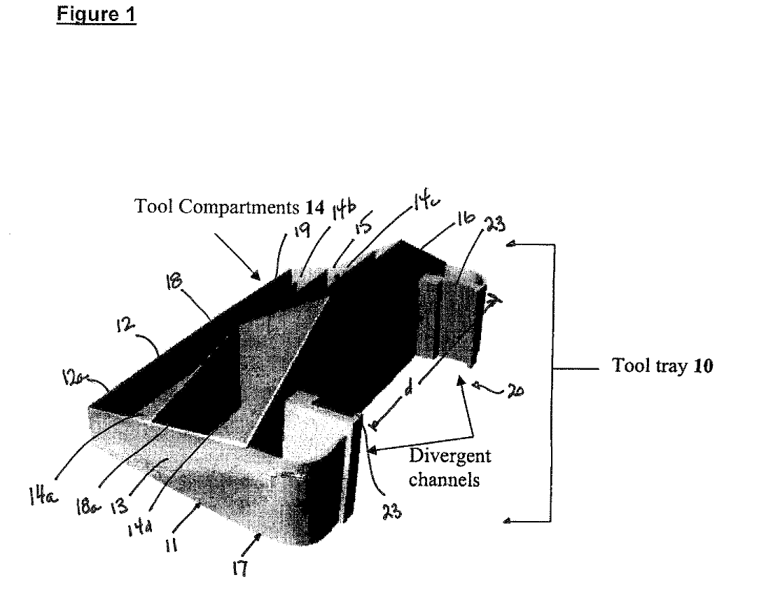

Managing tools and equipment when climbing and working from a step ladder can be a considerable challenge for both the professional and the hobbyist. Sometimes a tray is mounted on the ladder in which tools and equipment can be stored and made available for use. However, none of the previous ladder accessories provide the benefits of the invention described here. For example, the tray shown in FIG. 1 of U.S. Pat. No. 4,730,802 projects off the side of the ladder, which means that the ladder is liable to tip sideways when the tray is loaded. The tray shown in U.S. Pat. No. 6,341,666 is designed for clamping onto a built-in shelf on the step ladder. Having to wrestle with clamps while aloft on the ladder is cumbersome and may also create safety issues.

The invention described here takes advantage of the fact that many step ladders have struts, rails, or legs that diverge or flare from top to bottom. The inventors discovered that by equipping a tray with a bracket with diverging channels, the bracket can be secured to the diverging struts of the ladder in a way that can rigidly and reliably bear the weight of the tray and its contents. The inventors also discovered that the angle that struts diverge and the width of ladders at or near the top are usually about the same, meaning that the trays and tray supports of this invention can be built to dimensions that fit a range of different ladders of different heights and materials made by different manufacturers.

Attaching the tray on the front of the back of the ladder by way of the struts is a particularly convenient arrangement, because the attachment can be made removable—either when attached directly to the struts, or by way of a separate support bracket. The arrangement is also particularly safe, because it puts the center of gravity of the tray within the footprint of the ladder as a whole.

A tool tray according to the present invention can be mounted to the ladder easily due to the self aligning features of the diverging channels of the bracket. The operator can maintain a safe three-point contact with the ladder while mounting or dismounting the ladder with the tool tray (i.e., both feet and the other hand). The location of the tool tray allows for a stable platform from which to work. The location of the tool tray also prevents the ladder from tipping over when the user mounts or dismounts before or after the task to be performed.

### Illustrative Embodiments

The drawings provided with this disclosure show working embodiments of the invention that illustrate potential features and benefits. Except where explicitly stated or required, the features of the drawing are not intended to limit the invention in the claims presented below.

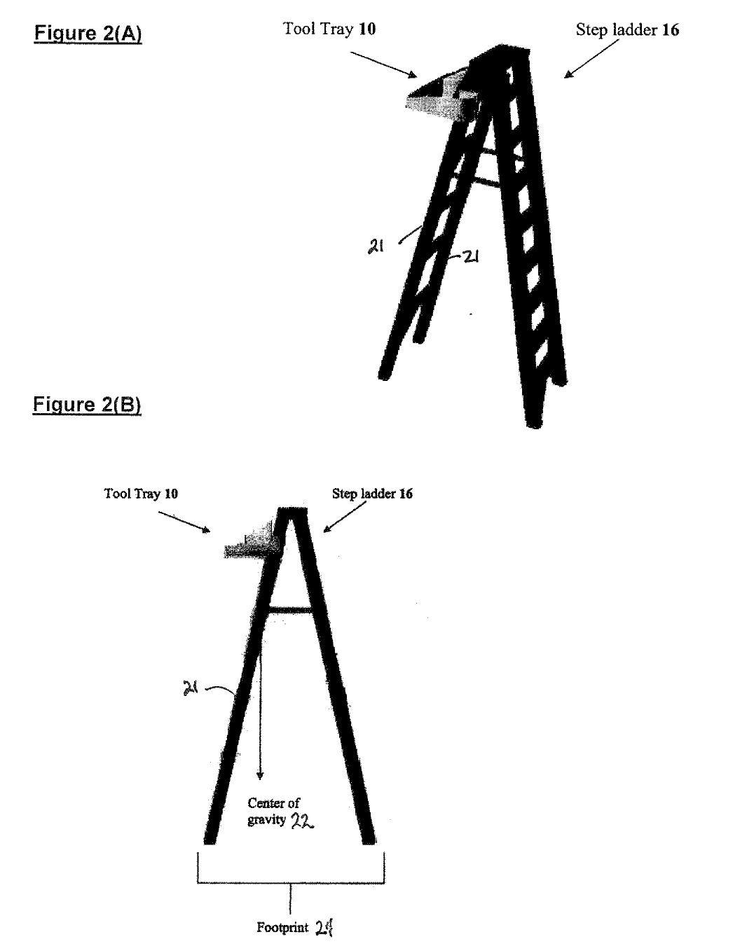

The trays and tray supports of the invention can be used for any purpose desired by the user. In general, they are designed for mounting on a so-called A-frame step ladder as illustrated in FIGS. 2(A) and 2(B). Step ladder 16 generally is shaped as an inverted V, so as to be self-supporting. The apex of the V is usually hinged to allow the ladder to be folded for carrying or storage. There is often a hinged brace between the two legs of the V on each side that constrains the distance the legs can be splayed apart when in use. This creates an “A” shape, and hence the name. However, this invention can be used on any ladder of suitable design. Unless otherwise stated or required, the term “step ladder” as used in this disclosure should be taken to include any self-supporting ladder that generally comprises a front with steps ascending upwards that is braced against a back that ascends to meet and support the back in what is substantially an inverted (and possibly truncated) V. The ladder may or may not be foldable or collapsible, and may or may not have a constraining brace.

Reference to the “front” of the ladder refers to the part with steps attached on the left and right side to struts that ascend on an angle that is somewhat less than vertical. For tall ladders, there may be multiple struts on the left and the right. The “back” meets and supports the front near the top, and may have bracing or a separate set of steps between two or more struts of its own. For most ladders, the tray and tray support of this invention can be attached to the front or the back interchangeably, although it is generally more convenient to attach it to the back opposite the front that the user intends to ascend. The left and right side of the ladder present the profile of the front and back, generally as the inverted V shape.

### One-Piece Tray

FIGS. 1, 2(A) and 2(B) show a particular one-piece tray generally indicated at 10 that illustrates one embodiment of the invention. The tray 10 has a substantially horizontal platform 11 supporting one or more open compartments 14 suitable for holding tools or equipment. The one or more open compartments 14 are formed by upstanding front 12, first side 13, second side 15 and back 16 walls around the periphery 17 of platform 11. Interior walls 18,19 running side to side or back to front or part way help define the compartments 14 In this illustration, there are multiple upwardly open compartments 14a, 14b, 14c, 14d for containing tools and/or equipment of different size. The compartments 14a-d are configured in such a way that front and back sides of the compartments present a profile that slopes downwards from where the tray is attached to the ladder. For example for compartment 14a, the front wall 12a is lower than the back wall 18a.

There is a bracket 20 at the back for engaging diverging struts 21 on a step ladder 16. The bracket 20 has channels, troughs, or vertical indentations 23 that are adapted to fit around the struts or legs 21 of a ladder 16 that diverge from top to bottom by about the same angle, specifically, around the left outside of the left strut, and the right outside of the right strut on the front or back of the ladder to which the tray 10 is being secured. The distance d between each side of the bracket 20 is chosen to secure the tray 10 to the ladder 16 at or near the top, or near the position midway up the ladder that will provide the user with convenient access to the tools and equipment in the tray.

The angle of the divergent channels 23 from the vertical is generally between about 3 to 10 degrees from the vertical, and typically between about 3 and 7 degrees from the vertical, or about 5 degrees±1 degree. The distance d between the two channels on each side of the bracket 20 measured at the top or narrowest width (from the inside surface) is generally between 10 and 18 or between 12 and 15 inches and typically about 13.5 inches, diverging outwards over the vertical span of the tray at the appropriate angle. If the bracket is 4.5 inches vertically, the distance between the two channels at the bottom is generally between 11 and 20 or between 13 and 16 inches, typically about 1425 inches. The profile and the width or depth of each channel may be adapted to fit around the struts of a particular ladder design, or may be kept a substantially rectangular shape of about 2 inches wide so as to make the tray fittable onto a range of different ladder designs by different manufacturers.

FIG. 2 shows the same tray attached to a ladder with diverging struts having an angle from the vertical that matches or approximates the angle of the channels on the bracket of the tray. When the ladder is positioned for climbing, the horizontal platform of the tray projects outwards from the front or back of the ladder to which it is attached. As a result, the center of gravity 22 of the tray or tray assembly is vertically positioned above and horizontally positioned within the footprint 24 defined by support struts 21 of the ladder.

### Tray and Separate Support

Another option is to use an assembly in which the equipment holding part of the tray and the means for attaching it to the ladder are organized in two or more separate components. The tray assembly may adopt any or all of the features of the one-piece design, as well as particular features of its own.

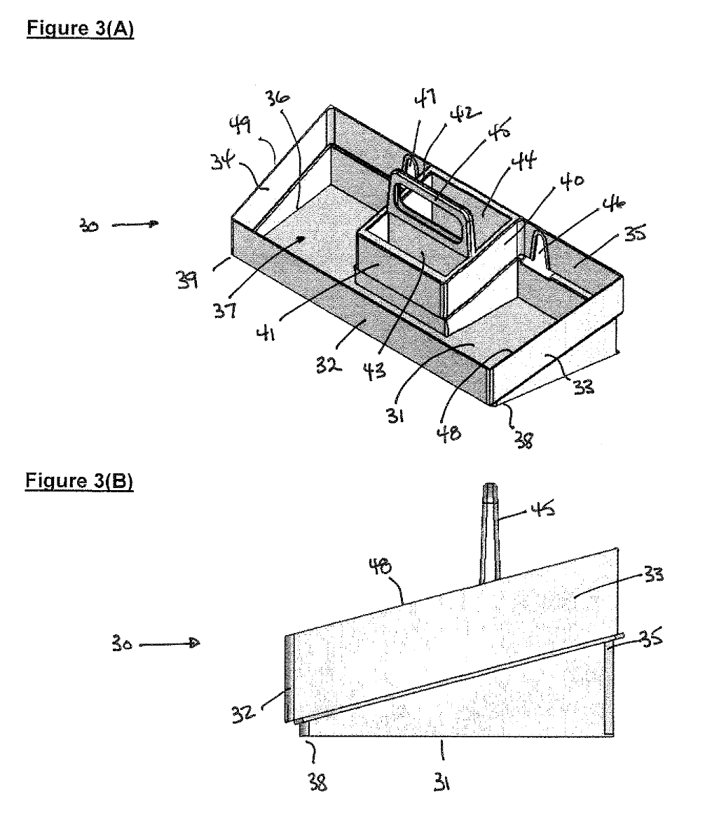

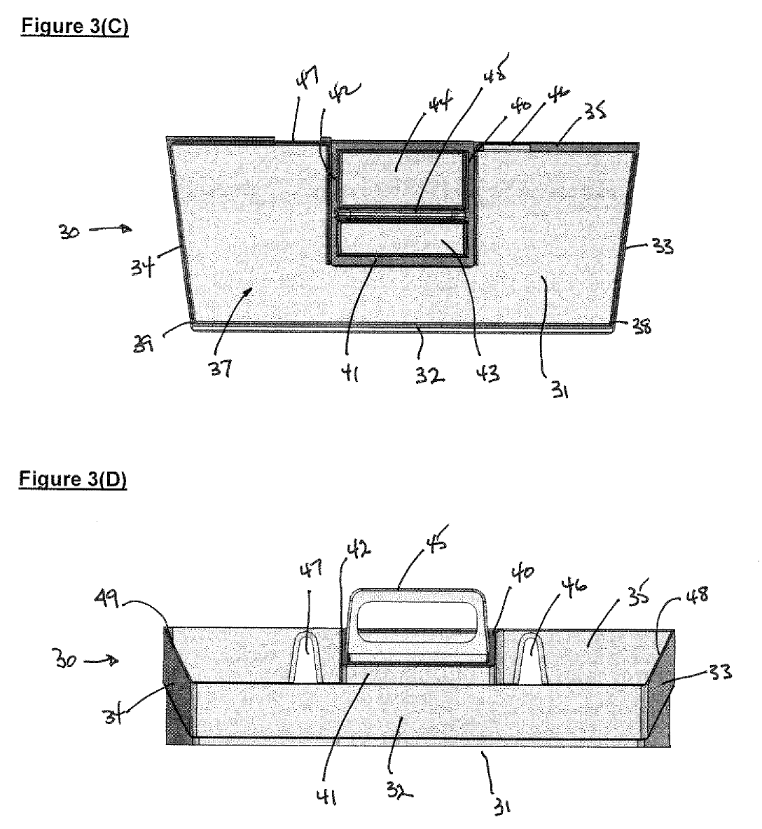

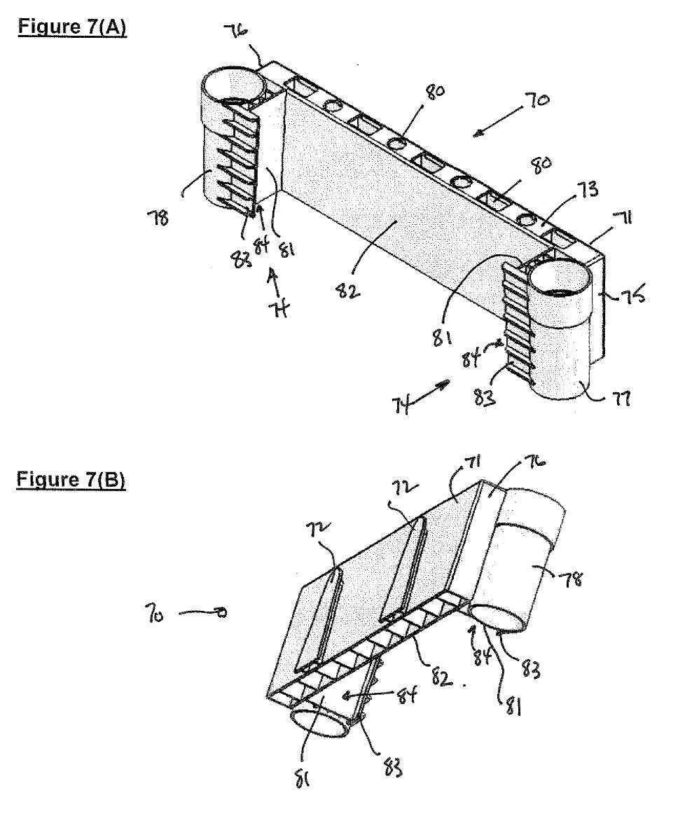

FIG. 3 shows an embodiment of a tool tray 30 according to the invention that is designed for attachment to a ladder by way of a separate support 70 shown in FIG. 7. The tray 30 comprises a substantially horizontal platform 31 with upstanding front 32, first 33 and second 34 side and back 35 walls around the periphery 36 of platform 31. From back to front, the top edge 48,49 of first 33 and second 34 side walls of the tray 30 have a downwards sloping profile. In the embodiment illustrated in FIG. 3, the front, side and back walls define one big compartment 37 that goes from the first side 38 to the second side 39 of platform 31 that can be used to hold tools, and in conjunction with interior walls 40,41,42 two small compartments 43, 44 around a handle 45 that can be used for holding screws, drill bits, or other small equipment. The handle 45 conveniently allows the tray 30 to be carried between job sites and up and down the ladder, and is generally placed within the tray so that the tray is roughly balanced from the handle when loaded. The handle may be made to slide downwards or otherwise be collapsible to facilitate storage when the tray is not in use.

The tray 30 is attached by way of its back wall 35 to a vertical face 71 of the support 70 (see FIG. 7) that goes on the ladder. In this example, the tray 30 has an opening 46, 47 on the back wall 35 adjacent the two small compartments 43, 44 sized and shaped to permit upwardly extending hooks, tabs, or inserts 72 on the vertical face 71 of support 70 that have essentially an inverted V-shape to fit through the openings and support tray 30 on hooks 72.

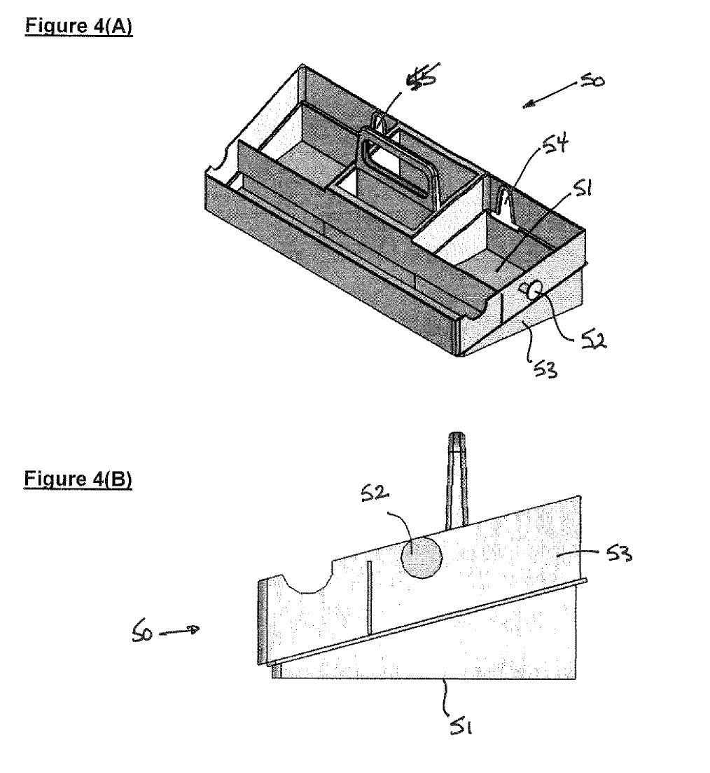

FIG. 4 shows a tool tray 50 having a somewhat different design specifically, the large compartment 51 is divided to permit its contents to be organized. There is also a hook 52 on the right side 53 which can be used to suspend or drape other equipment or attachments such as power cords. This tray is sized and has openings 54, 55 that allow it to be fitted onto the same support 70 as the tray in FIG. 3.

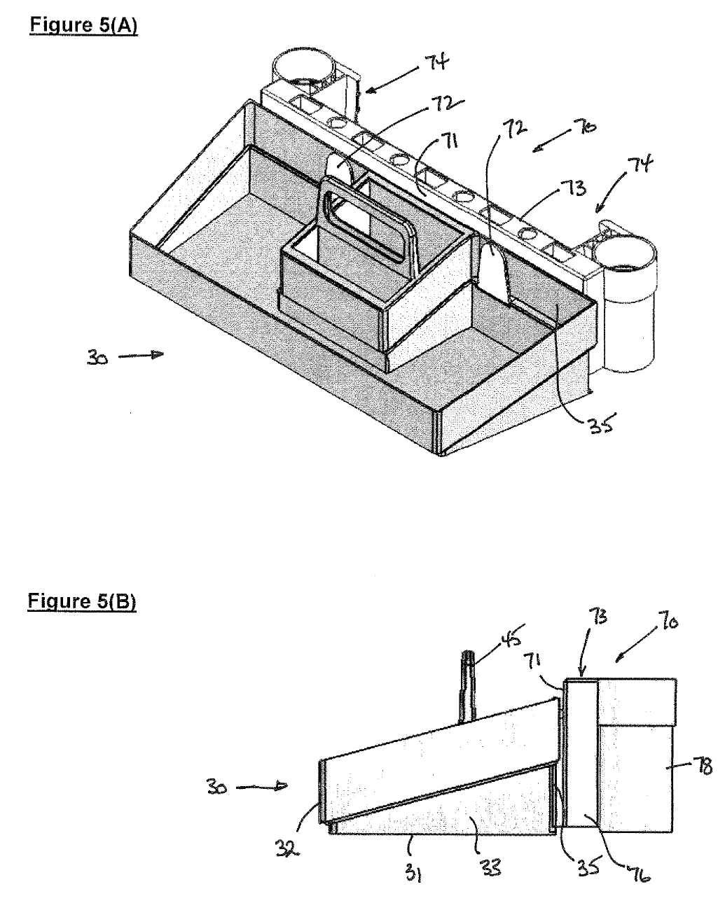

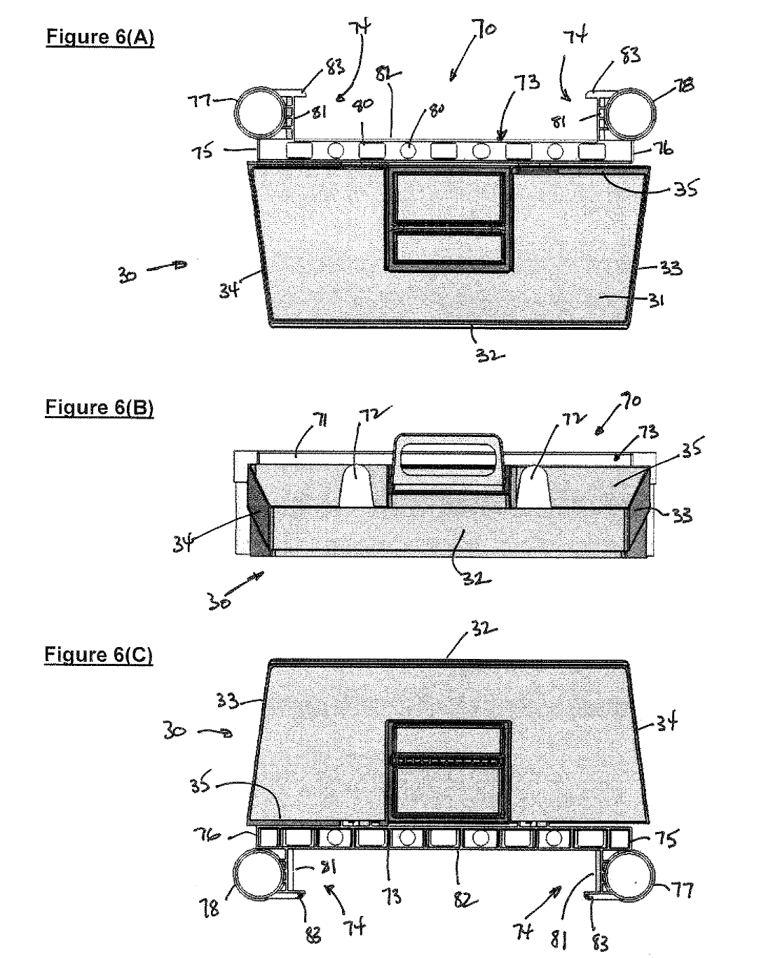

FIGS. 5 and 6 show an assembly in which a tray 30 is attached securely by way of openings 46, 47 in its back wall 35 to matching hooks 72 attached to the front vertical face 71 of a support 70, which in turn can be attached to a ladder. Any other suitable means can be used for attaching the tray 30 to the support 70, including various arrangements of hooks, tabs, inserts, clamps, bolts, and so on. Arrangements that allow the tray to be removed easily are preferred, because this allows the tray to be taken off the ladder without too much trouble, so that the ladder can be folded for storage. The hook and opening arrangement shown here can be reversed, so that the hooks are on the back wall 35 of the tray 30, and insert into rings, holes, or openings at or near the front vertical face 71 of the support 70.

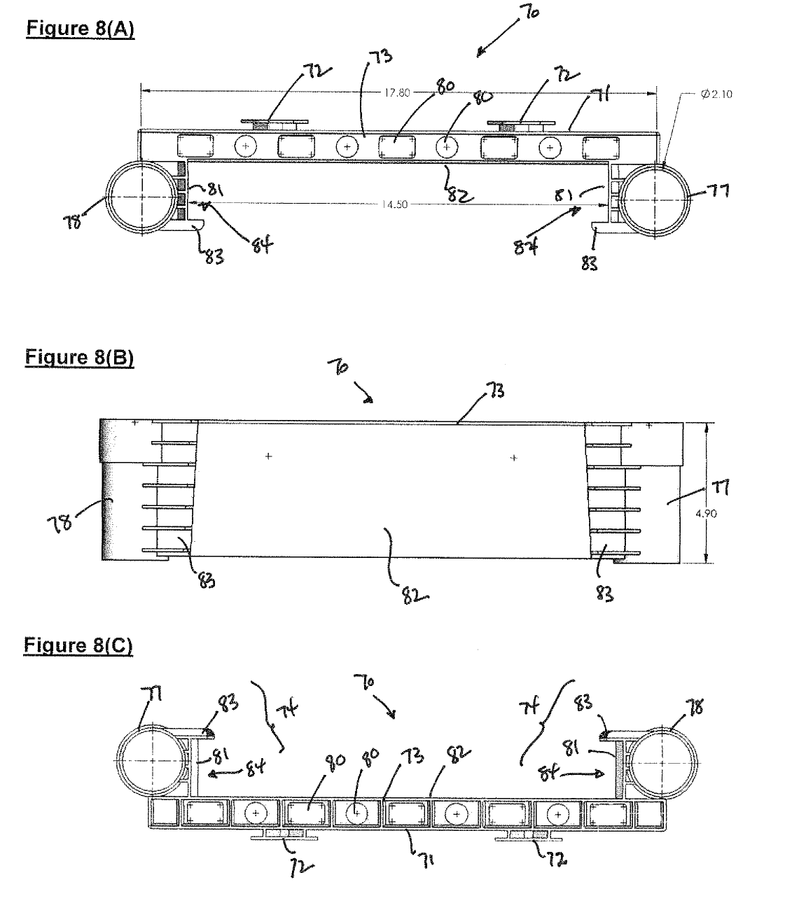

FIGS. 7 and 8 show an example of a tray support 70 used with the trays 30, 50 illustrated in FIGS. 3 and 4. In this illustration, the support 70 comprises a panel section 73 having bracket means 74 adjacent opposite ends 75,76 of the panel section 73 that are sized and shaped to fit around the struts of the ladder. The hooks 72 on the front vertical surface 71 of the panel section 73 of the support 70 are essentially an inverted V-shape, accommodated to insert into the inverted V-shape openings 46, 47 in the corresponding tray 30, 50. The inverted V-shape facilitates sliding of the tray onto the hooks, guiding the tray laterally and downwards to a secure and fixed position.

The tubular structures 77, 78 shown on each end 75, 76 of the support 70 are sized to accept a power drill (about 2⅛ inches), and can be adapted to fit other equipment. Besides providing a place to put tools and equipment that is separate and apart from the tray itself, the tubes 77, 78 provide a strengthening role for the bracket means 74, helping resist outward forces from the struts of the ladder against the opposing channels of the bracket, which otherwise might compromise or weaken the hold of the bracket on the ladder. The panel section 73 is deep enough to support the tray 30, 50, and in this example is substantially hollow inside to save weight and manufacturing costs. Openings 80 at the top of the panel section 73 accept tools and equipment that are long and thin in shape, such as screwdriver blades, and the handles of pliers.

As shown in FIG. 7(A) shows the bracket means 74 illustrated in this embodiment comprise a first wall section 81 extending from one side outwardly from the back surface 82 of panel section 73 and a perpendicular flange 83 at its distal end so that the first wall section 81, of the back surface 82 of the panel section 73 and the perpendiciular flange 83 define a divergent channel 84 sized and shaped to fit over diverging struts of the ladder

Matching the angle of the diverging channels 84 with the angle of the diverging struts of the ladder is usually sufficient for the support 70 (and hence the tray) to be attached to the ladder in a secure and stable fashion. Alternatively or in addition, the support can be secured to the ladder or ladder struts by way of other attachment means, including screws, bolts, clamps, and permanent welding. When these additional securing means are used, the bracket having diverging channels is optional, and the support can be attached to ladders having parallel struts down the front or back side that don't diverge.

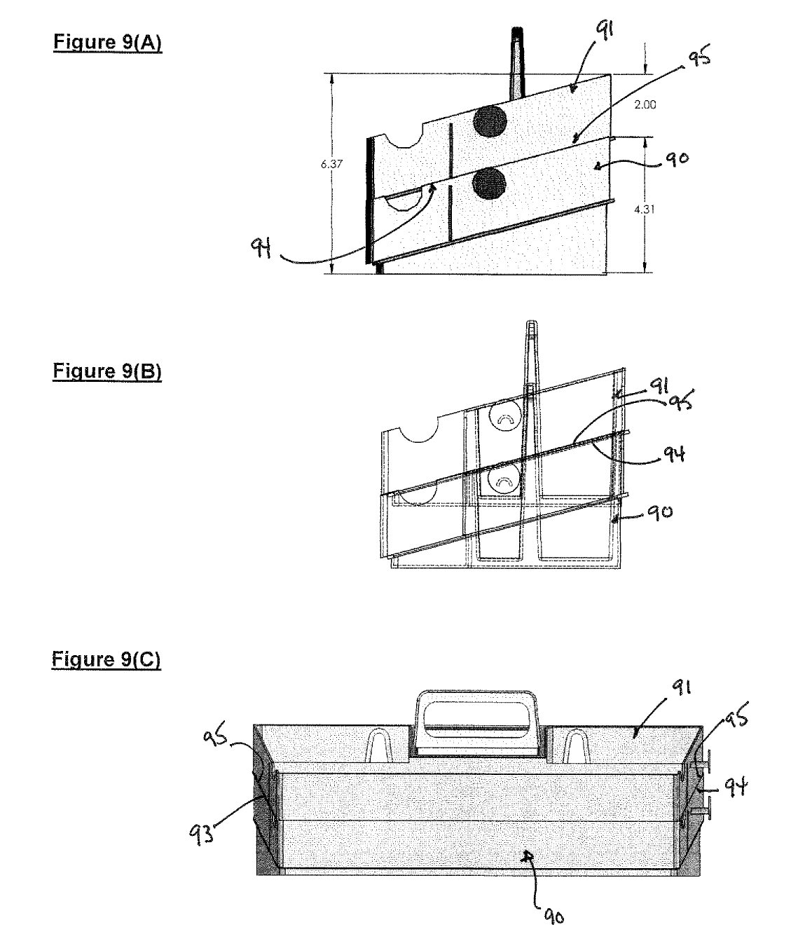

FIG. 9 illustrates an embodiment of the invention which is a particular stackable tray design. The lower tray 90 in the stack is shaped so that a proportion of upwards oriented surfaces 93 and edges 94 mates with or fits underneath some of the downwards oriented surfaces 95 of the tray 91 above. By providing trays with both such upwards and downwards surfaces, multiple trays can be stacked securely in any order. Here, besides the mating of the outside edges, the upper tray has an insert that goes into the lower tray, and the divider that supports the handle is hollow so as to accept the divider from the tray below.

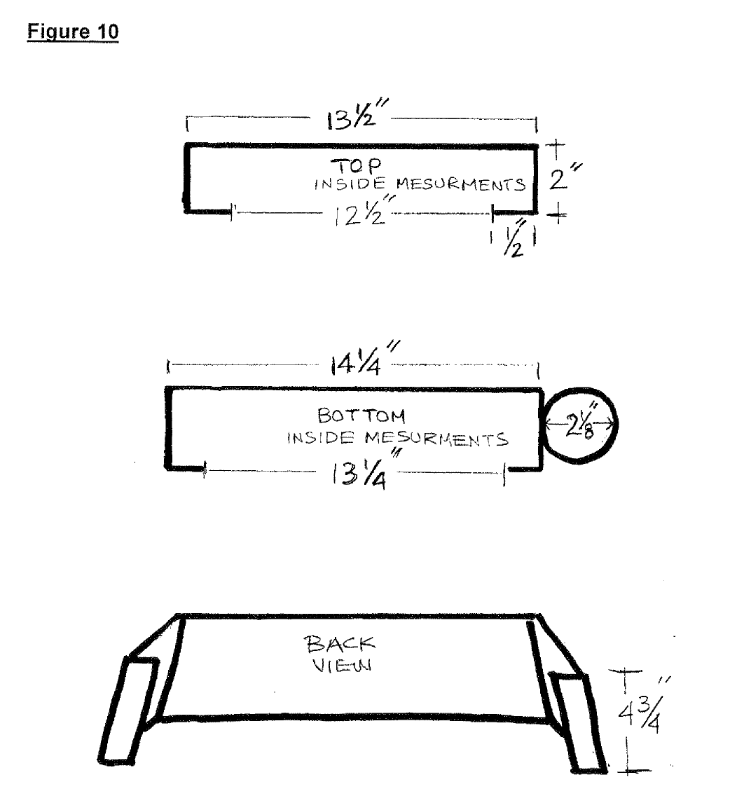

FIG. 10 shows preferred measurements for the support and bracket means that goes around the ladder struts. As for the one-piece tray, the angle of the divergent channels is generally between about 3 to 10 degrees from the vertical, and typically between about 3 and 7 degrees from the vertical, or about 5 degrees±1 degree. The distance between the two channels on each side of the bracket measured at the top or narrowest width (from the inside surface) is generally between 10 and 18 or between 12 and 15 inches and typically about 13.5 inches, diverging outwards over the vertical span of the tray at the appropriate angle. If the bracket is 4.5 inches vertically, the distance between the two channels at the bottom is generally between 11 and 20 or between 13 and 16 inches, typically about 14.25 inches. The profile and the width or depth of each channel may be adapted to fit around the struts of a particular ladder design, or may be kept a substantially rectangular shape of about 2 inches wide so as to make the tray fittable onto a range of different ladder designs.

### Manufacturing and Use

The trays and tray supports of this invention can be made of any suitable material that is sufficiently rigid and weight-bearing, such as metal, wood, graphite, or a durable plastic such as polypropylene. When made of a denser material, the components (particularly the support) may be hollow to limit weight and facilitate manufacturing. Step ladders for use in and with this invention are available from retail hardware suppliers under brand names such as ProLite™ or Industrial Lite™. Alternatively, ladders, trays, and supports can be manufactured together or apart in accordance with this invention to the manufacturer's specifications.

To put the invention into use, the user secures the tray to the ladder before or after filling the tray with tools and/or equipment, and before or after the ladder is positioned for climbing to attend to the task at hand. When put together and the ladder is positioned for climbing, the horizontal platform of the tray projects outwards from the front or back to which it is attached. Optionally, the tray or tray support can be further secured to the ladder by other means, such as clamping or bolting. However, when the tray or tray support has diverging channels that engage diverging struts on the ladder, this is generally not required.

When a separate tray and support are used, it is often helpful to attach the support to the ladder before carrying the ladder to the job site, and leaving it on the ladder for subsequent projects. Once the ladder is positioned for a particular task, the tray can be inserted securely onto the support—either before or after the user mounts the ladder. Besides the handle a shoulder strap can be incorporated into the tray design to help the user to carry the tool tray up the ladder.

Once the ladder and the tray are in position, they can be used for any purpose desired by the consumer. Homekeepers can use the invention for changing light bulbs or mounting drapery. Electricians can use the invention to hold equipment such as electrical boxes, wiring, plugs, and tape, tools such as wrenches, pliers, wire trimmers, and electrical equipment like soldering irons. Painters can use the invention to hold cans of paint and painting supplies, such as calk and calking guns, brushes, trimmers, and trays. Heating and air conditioning professionals can use the invention to hold various pipes, connectors, and ductwork, along with their own specialized tools. Housebuilders can use the invention to hold wood, trim, sheet rock, power tools like drills and screw drivers, along with anything else they might require.

In accordance with the weight bearing capacity and the versatility of the invention, trays can be used in either the one-piece or supported design that provide attributes for particular users or tasks. Where a support is used, different trays for different tasks can be provided that fit over the same support, or on similar supports on different ladders. For example, the tray can have a multitude of small compartments (open, covered, or latched) for containing small equipments like screws and electrical attachments. Custom brackets can be added to the tool tray for hanging extension cords and or power tools. The tray can be provided with compartments dimensioned and shaped with a view to accommodating particular items: for example, wide round compartments for paint cans, cup holders, and tall deep compartments for fluorescent light bulbs, or lengths of wood or piping.

As already indicated, the various components of the products of this invention can be sold preassembled, or in kit form. A kit for assembling the tray assembly has one or more trays and one or more supports. A kit for assembling the ladder and the tray together has the ladder, and either a one-piece tray or a tray and tray support. The ladder may also be manufactured and sold with the tray or with just the support already attached.

The various examples and illustrations referred to in this disclosure are provided for the benefit of the reader, and are not intended to limit the implementation or practice of the invention except where explicitly referred to or otherwise required in the claims that follow. The devices and methods of this invention can be effectively refined or modified by routine optimization without departing from the spirit of the invention embodied in the claims.

The invention claimed is:

1. A step ladder assembly, comprising:
a) a step ladder comprising a pair of upward support struts on a front and/or a back side, wherein at least one of said pairs has struts that diverge from each other from top to bottom; and
b) a tray or tray assembly comprising a substantially horizontal platform supporting one or more open compartments suitable for holding tools or equipment;
wherein the tray is attached to each of the pair of diverging struts on the front or the back of the ladder such that when the ladder is positioned for climbing, the horizontal platform projects outwards from the front or back to which it is attached.

2. The step ladder assembly of claim 1, wherein the tray or tray assembly comprises a bracket that has opposed diverging channels that engage said diverging struts so as to support the tray and its contents when the ladder is positioned for climbing.

3. The step ladder assembly of claim 2, comprising a tray assembly in which a tray suitable for holding tools or equipment is removably attached to a separate support that has opposed diverging channels that engage said diverging struts so as to support the tray and its contents to the ladder when the ladder is positioned for climbing.

4. The step ladder assembly of claim 3, wherein the support comprises a plurality of hooks adapted to receive openings on the tray, thereby supporting the tray and its contents when the ladder is positioned for climbing.

5. A tray or tray assembly for attachment to a step ladder,
wherein the step ladder comprises a pair of upward support struts on a front and/or a back side, wherein at least one of said pairs has struts that diverge from top to bottom;
wherein the tray or tray assembly comprises a substantially horizontal platform supporting open compartments suitable for holding tools or equipment;
wherein the tray or tray assembly comprises a bracket that has opposed diverging channels that engage diverging struts on the front or the back of the ladder, such that when the ladder is positioned for climbing, the horizontal platform projects outwards from the front or back to which it is attached.

6. A tray according to claim 5, comprising a bracket that has opposed diverging channels that removably engage said diverging struts so as to support the tray and its contents when the ladder is positioned for climbing.

7. A tray assembly according to claim 5, comprising a tray that is adapted to be removably attached to a separate support that has diverging channels adapted to engage diverging struts in said ladder so as to support the tray and its contents when the ladder is positioned for climbing.

8. The tray assembly of claim 7, wherein the support comprises a plurality of hooks adapted to receive openings on the tray, thereby supporting the tray and its contents when the ladder is positioned for climbing.

9. The tray assembly of claim 8, wherein the support comprises two hooks that are essentially an inverted V-shape, are attached to a surface of the support facing outwards from the ladder, and are adapted to receive openings on the tray such that the tray is held securely against said outward facing surface of the support.

10. The tray assembly of claim 7, wherein the support comprises a plurality of upwardly oriented openings for receiving hand tools separate and apart from the tray.

11. The tray or tray assembly of claim 5, wherein the opposed diverging channels diverge at an angle from the vertical of about 5 degrees.

12. The tray or tray assembly of claim 5, wherein the tray comprises a handle for carrying the tray when not attached to a ladder.

13. The tray or tray assembly of claim 5, wherein the tray further comprises a cup-holder.

14. A kit for assembling a tray assembly according to claim 7, comprising said tray and said support.

15. The kit of claim 14, comprising a plurality of said supports for mounting on different ladders and/or a plurality of said trays for holding different tools or equipment.

16. A method for securing a tool tray to a step ladder, comprising obtaining a tray assembly according to claim 7, attaching said support to a pair of divergent support struts on the front or the back of said ladder, and attaching said tray to the support such that when the ladder is positioned for climbing, the horizontal platform projects outwards from the front or back to which it is attached.

17. A step ladder assembly, comprising:
a) a step ladder comprising a pair of upward support struts on a front and/or a back side, wherein at least one of said pairs has struts that diverge from each other from top to bottom;
b) a tray support that has opposed diverging channels for engaging said diverging struts, and that also has a plurality of hooks adapted to receive openings on a tray so as to support the tray and its contents when the ladder is positioned for climbing; and
c) a tray comprising a substantially horizontal platform supporting one or more open compartments suitable for holding tools or equipment, the tray being adapted to be removably attached to said support by way of said hooks;
wherein the tray is attached by way of the support to the ladder such that when the ladder is positioned for climbing, the horizontal platform projects outwards from the front or back to which it is attached.

18. A step ladder for creating the assembly of claim 17, comprising said tray support attached to said ladder in such a way as to receive said tray such that when the ladder is positioned for climbing, the horizontal platform of the tray projects outwards from the front or back to which it is attached.

19. A kit for assembling a tray assembly according to claim 17, comprising said ladder, said support, and said tray.

20. The step ladder assembly of claim 17, wherein the center of gravity of the tool tray is vertically positioned above and horizontally positioned within the footprint defined by support struts of the ladder when positioned for climbing.
